(19) United States
(12) Patent Application Publication
(10) Pub. No.: US 2008/0140737 A1
(43) Pub. Date: Jun. 12, 2008

(54) DYNAMIC MEMORY MANAGEMENT

(75) Inventors: Blaine Garst, Los Altos, CA (US); Bertrand Philippe Serlet, Palo Alto, CA (US)

Correspondence Address: WONG, CABELLO, LUTSCH, RUTHERFORD & BRUCCULERI LLP, 20333 SH 249, SUITE 600, HOUSTON, TX, 77070, US

(73) Assignee: Apple Computer, Inc., Cupertino, CA (US)

(21) Appl. No.: 11/608,345

(22) Filed: Dec. 8, 2006

(51) Int. Cl. G06F 12/00

(52) U.S. Cl. 707/206

(57) ABSTRACT

Methods, devices, systems and computer program products for the automatic management of dynamically allocated program memory (“garbage collection”s are described. In one implementation, identification of reachable objects is performed substantially concurrently with continued execution of computational threads (mutator execution). Only during a brief, catch-up scan, are mutator threads blocked—and then only one thread at a time. In another embodiment, generational collection is provided wherein retained nodes are not moved. In still another implementation, functions may be registered with the garbage collector task. These functions may be executed periodically during a collection cycle to determine if a specified event (e.g., timer expiration or user interface event such as a mouse “click”) has occurred. If the specified event is detected, garbage collection may be aborted.

### BACKGROUND

The invention relates generally to computer program memory management and more particularly to the automatic management of dynamically allocated memory—“garbage collection.”

Computer programs consist of memory and a processor, wherein the memory retains instructions which the processor executes. Systems that run computer programs may be as simple as a single processor (“CPU”) with direct access to memory (e.g., a program running in an executive style kernel), or as complex as a multi-threaded process in a multi-tasking operating system running on a multiple-core multi-CPU hardware.

Programmers may program a system in binary form or in higher-level forms that may then be translated into binary. The lowest level programming languages are called “assembly” languages and are CPU-specific. Higher level programming languages such as C, Objective-C and C++ provide useful patterns of programming such as subroutines, stacks, and objects, yet still allow the programmer to readily manipulate bit patterns within the memory system. Objects are a pattern of programming that identify small regions of memory as objects and provide various schemes for specialized manipulation. Runtime-based languages such as LISP, Smalltalk, Java and C# are designed to avoid such access and in return provide automatic memory management of their objects by way of runtime instructions provided by that language system. (JAVA is a registered trademark of Sun Microsystems, Inc. of California.)

It is a generally recognized practice in computer programming to use what is known as a heap to provide for the dynamic creation (“allocation”) and recovery (“deallocation”) of small regions of memory known variously as nodes, blocks, cells, or objects. There may be several heaps in a single program. A runtime-based language generally provides its own heap management instructions. Computer programs written in non-runtime based languages require that heap based nodes be explicitly allocated and deallocated. Determining when a node is no longer referenced elsewhere in a program is often a great difficulty to the programmer and is a source of errors and excess memory use due to unused nodes that do not get deallocated.

A garbage collected heap is one where node deallocation is performed by runtime code rather than explicitly by programmer code. Most runtime-based languages provide this facility so that programs written in these languages do not have to manage the complexity of determining when dynamically allocated nodes can be deallocated. Prior art garbage collection technology is discussed in Garbage Collection Algorithms for Automatic Dynamic Memory Management by Richard Jones and Rafael Lins, published by John Wiley & Sons, Copyright 1996. This reference is incorporated by reference as indicative of the prior art.

Garbage collected systems generally provide for the compaction of nodes within the heap by copying their contents to a new region and updating all references to that node with the new region location. There are several drawbacks this scheme. The copying and updating is normally done while all threads of computation are halted which can be undesirable. It is difficult or impossible to provide direct access to the nodes to code (instructions) written in other languages because the runtime system does not have enough knowledge to update addresses. Conservative Garbage Collection systems where nodes are not moved are uncommon. These systems generally use a mark-sweep system that consumes a significant amount of CPU time while all threads of computation are blocked.

Each prior art garbage collection technology (e.g., exact or conservative) has its own limitations. Thus, it would be beneficial to provide a mechanism to dynamically reclaim unused memory without unduly interfering user program execution.

### SUMMARY

In one embodiment the invention provides a method to manage dynamic memory. The method includes identifying heap objects (associated with an executing program having multiple threads) as reachable and not reachable in a manner that blocks only one of the multiple threads at a time. During the act of identifying, dynamic memory management operations may be aborted on detection of any one of a number of events (e.g., time-critical computational actions or user interaction events). Once identified, non-reachable heap objects are reclaimed in such a way that retained heap objects (i.e., objects identified as reachable) are not copied. Methods in accordance with the invention may be stored in any media that is readable and executable by a programmable control device and/or computer system.

### BRIEF DESCRIPTION OF THE DRAWINGS

FIG. 1 shows, in block diagram form, the environment within which a garbage collector in accordance with one embodiment of the invention executes.

### DETAILED DESCRIPTION

Memory allocation and recovery are common operations within many modern computer systems and, as such, their implementation can significantly affect a computer system's overall performance. In particular, the specific choice of data structures used to implement a dynamic memory management system (i.e., a garbage collector) can strongly affect that system's overall performance. For example, a specific choice of data structures may improve one aspect of performance (e.g., overall memory utilization) at the expense of another (e.g., allocation speed). It will be recognized that while the specific data structures used to implement any given memory management system typically vary from implementation to implementation and, in addition, may be complex in order to avoid particular performance issues (e.g., thread synchronization), the following description makes use of simplified data structures to explain the salient and novel aspects of the claimed invention, variations of which will be readily apparent to those skilled in the art. Accordingly, the claims appended hereto are not intended to be limited by the disclosed embodiments (e.g., the use of illustrative and simplified data structures), but are to be accorded their widest scope consistent with the principles and features disclosed herein.

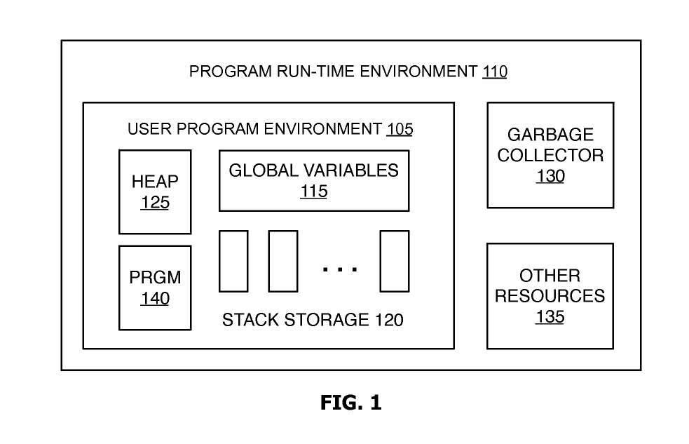

Before describing the operation of a garbage collector in accordance with various embodiments of the invention, it is useful to consider the operational environment within which such a garbage collector executes. Referring to FIG. 1, operational environment 100 includes user program environment 105 and program run-time environment 110. User environment 105 includes user program 140, global variable storage 115, stack storage 120 and heap storage 125 (hereafter referred to as the “heap” and CPU registers (not shown). Heap 125 may be comprised of one or more memory blocks, some of which may be used for the allocation of objects subject to garbage collection and some of which may be used for the allocation of objects not subject to garbage collection (e.g., memory buffers and image, sound and network processing code). In addition, heap 125 may be but one of a plurality of heaps available to the system. Run-time environment 110 provides garbage collector executable code 130 and other resources 135 such as, for example, storage, libraries and/or application programming interfaces (“APIs”).

In one implementation, garbage collector 130 is an object-oriented module (hereinafter referred to as the “collector”s that is instantiated shortly after run-time environment 110 is established. As part of its initialization process, collector 130 typically has a number of operational parameters set through, for example, procedure calls. Illustrative operational parameters include, but are not limited to, the maximum number of generations permitted (if generational collection is supported) and whether finalization operations are to be performed prior to memory reclamation (if finalization operations are supported). Collector 130 also includes (or has access to) information or variables related to, for example, locks, busy status, marking phase abort operations (if supported) and the like.

While the invention is not so limited, for purposes of the following description, collector 130 will be assumed to allocate memory in terms of “nodes” and to operate in a single address space where multiple threads of execution may be performing memory allocation requests. As used here, a node is a data structure (i.e., an object) that incorporates sufficient memory to store the information for which a thread allocates the node and/or a pointer to that information and, in addition, various metadata used by collector 130 (an alternative embodiment of this metadata is discussed below.)

Using the simplified collector and node data structures defined via C-like syntax pseudocode in Tables 1 and 2, a high-level description of a garbage collection cycle in accordance with one embodiment of the invention is shown in Tables 1-8 (also in pseudocode). At a high level, garbage collector 130 starts with the thread stacks 120 and global memory locations 115 that have been registered with the collector and also any nodes that have been noted as having their addresses stored elsewhere, these forming what is generally regarded as the “root set,” and proceeds to explore these nodes for references to other nodes until all reachable nodes have been found. Those nodes not reachable are referred to as unreachable any are considered garbage and may be deallocated or reclaimed.

More specifically, once initialized, each program thread that wishes to use nodes from the collector must register their thread with the collector. For purposes of this discussion we assume that this is done as part of thread creation, but it will be well understood by those of ordinary skill in the art that this may be done by the programmer explicitly or by other means. Generally speaking, a program allocates a node by calling a memory allocation routine requesting an allocation of the desired size. The address of the node may be stored in a global variable by calling a global write barrier routine with the address of the variable and the desired node address. Similarly, a node address value may be stored into another node by calling node write barrier routine with the address of the node value, the node being stored into, and the slot within the node that the value should be stored at. If a node address will be stored somewhere else, an add external reference routine may be called with the nodes address. Later, if the node address is no longer needed elsewhere, a remove external-reference routine may be called. For purposes of illustration, add external reference and remove external reference routines may be called in an overlapping fashion as long as there are more add-references than remove-references. As long as there are unmatched remove-reference calls for a particular node that node may be considered a member of the root set and it and any strongly referenced nodes will not be collected.

Collector 130 in accordance with one embodiment of the invention supports a weak reference system. In this context, a node that is reachable from the root set by some chain of references is said to be strongly reachable. If, however, the only way to reach a node involves at least one weak reference, the node is said to be weakly reachable. A node is considered by collector 130 to be in-use if it is strongly reachable. Weakly reachable nodes, like unreachable nodes, are eligible for collection. Thus, a weak reference system permits an application to refer to a node without keeping it from being collected. If collector 130 collects a weakly reachable node, all weak references to that node are set to null so the node can no longer be accessed through the weak reference. A weak reference to a node may be stored into arbitrary memory by calling a register weak global routine with the address of that memory and the node's address. In one embodiment, making the same call with a node address of “O” will remove the arbitrary memory address from the collector's weak reference table. The arbitrary memory address is likely to be either a global memory or an address within another node. Without loss of generality, we assume that the finalize routine (if implemented) for a node will deregister the interior node address from the weak reference system.

In practice, collection of heap 125 by collector 130 may be initiated implicitly or explicitly. Implicit collection is initiated when a thread attempts to allocate a node but fails because there is insufficient heap memory to satisfy the request. If the collection cycle is successful, the thread is allocated the requested memory and continues to execute. If the collection cycle is not successful, the heap may have additional memory allocated to it through, for example, virtual memory mechanisms, after which the requested memory is allocated to the thread. Explicit collection is initiated when a (user or system) thread expressly requests a collection cycle. In one embodiment, collector 130 executes using the thread that made the (implicit or explicit) collection request. In another embodiment, collector 130 executes on a dedicated (system or kernel) thread.

TABLE 1
Garbage Collector Pseudo-Code

| | |
|---|---|
| struct Collector { | |
| // option flags | |
| int maxGeneration; | // Maximum number of generations |
| | permitted. |
| int abortCheckThreshold; | // Number of nodes to check before |
| | // checking to see if collection cycle |
| | should be aborted. |
| bool *shouldAbort( ); | // Function called if collection cycle |
| | aborted. |
| bool isScanning; | // Used to signal a collection cycle is |
| | in progress. |
| bool needsScan | // Used to indicate a scan operation is |
| | needed. |
| Node nodes; | // Pointer to a Node structure. |
| Thread threads; | // Pointer to a Thread structure. |
| void *finalize(Node *) ; | // Pointer to finalizer routine. |
| Table *weakReferences; | // Supports a weak reference system. |
| struct Lock allocationLock; | // Synchronization structure. |
| struct Lock collectionLock; | // Synchronization structure. |
| struct Lock garbageLock; | // Synchronization structure. |

TABLE 2
Node Structure Pseudo-Code

| | |
|---|---|
| struct Node { | |
| bool inUse; | // Indicates node is in use. |
| bool isScanned; | // Indicates node has been scanned. |
| bool wasReached; | // Indicates node was reachable. |
| bool isObject; | // Indicates node is an object |
| | (i.e., not just bits). |
| bool hasYounger; | // Indicates node points to a younger |
| | generation |
| | // object/node, e.g., through userData[ ]. |
| bool needsScan; | // Indicates node has not been scanned. |
| bool isGarbage; | // Indicates node is garbage |
| | (may be reclaimed). |
| int generationNumber; | // Indicates node's current generation. |
| int externalReferenceCount; | // Number of times node referenced by an |
| | // external object. |
| Node *userData[ ]; | // Pointer to thread/user data. |
| } | |

Referring to Table 3, when a collection cycle is initiated, a collection lock is taken so that any thread that attempts to initiate a concurrent collection cycle is blocked. It will be appreciated that blocking threads making subsequent collection requests is a policy decision and that other options are available. For example, rather than blocking the thread issuing a second (or third, . . . ) collection request, the second (or third . . . ) thread may contribute to the in-progress collection by scanning and/or finalizing objects. Next, collection is initiated via the collectNoLock function (see Table 4). Once the collection is complete (or aborted, see discussion below), the lock is released so that node allocations may continue to occur during collection.

TABLE 3
Collection Pseudo-Code

bool collect(struct Collector *collector) {

| | |
|---|---|
| int whichGen; | // Local control variable that identifies which |
| | // generation to collect. |

| | |
|---|---|
| whichGen = whichGenerationToCollect(collector); | // Identifies which |
| | // generation to |
| | collect. |

| | |
|---|---|
| if(whichGen == −1) return False; | // Don't collect. |
| lock(collector->collectionLock); | // Take collection lock. |
| result = collectNoLock(collector); | // See Table 4. |
| unlock(collector->collectionLock); | |
| return result; | |
| } | |

Referring to Table 4, during an all generation collection operation each node's metadata is initialized and collector 130's isScanning flag (see Table 1) is set to indicate a collection cycle is in progress. Next, each thread's stack and processor registers are scanned for references to heap memory followed by a scan of the heap itself (see Table 6). Up to this point, threads have not been blocked and, as such, continue to execute as normal. Following the heap scan operation, each thread is blocked in turn (i.e., one at a time) and heap 125 is rescanned (completely in accordance with Table 6 or generationally in accordance with Table 7) to identify any addresses that may have been moved within the stack in such a manner as to cause collector 130 to miss them. In one embodiment, when collector 130's isScanning field is set (see Table 1), any newly allocated node is marked as needing to be scanned in a peremptory manner. While this may allow nodes that become garbage to not be collected, it allows threads to proceed with allocation during collection. (This is a policy choice and we illustrate the more difficult option without loss of generality.) Similarly, when an add-reference or store-reference action occurs while collector 130's isScanning field set, the affected node is also marked as needing scanning. Again, the node may yet become garbage before the collection finishes but also allows, as a policy choice, for threads to proceed. After all threads have been stopped (one at a time) and examined, the allocation and garbage locks are taken and all remaining nodes that need to be scanned are examined. The list of garbage is determined and the allocation and garbage locks removed. During this short time other threads may block. Finally, nodes marked as “garbage” are reclaimed—with any finalizer routine executed as desired.

Some systems, like Java and C#, allow nodes to be revived during their finalize procedure such that their memory and any nodes that they reference must all not be immediately reclaimed. In one embodiment, no nodes are finalized. In another embodiment, only some nodes are finalized. In still other embodiments, all nodes are finalized. In some embodiments, nodes that are finalized are not immediately recovered. In this latter embodiment, nodes that are unmarked (would be garbage) but wish to be finalized may have another field “has-been-finalized.” The algorithm is modified such that, after all threads have been examined and all nodes that need to be examined are examined, all nodes that wish to have a finalizer function invoked are marked needsScan and they are fully examined and put on a list. After sending finalize commands to these objects they are marked has-been-finalized. Garbage is thus, is allocated and not marked and if wants to be finalized then has been finalized.

TABLE 4
Collect Without Locking Pseudo-Code

bool collectNoLock(struct Collector *collector, int generation) {

| | |
|---|---|
| bool shouldAbort; | // Local control variable; |
| for(node in collector->nodes) { | // Initialize node's metadata for |
| node->wasReached = False; | // collection cycle. |
| node->isScanned = False; | |
| node->hasYounger = False; | |
| } | |
| collector->isScanning = True; | // Indicates collection cycle is in progress. |

for(thread in collector->threads) { // Scan all threads' registers and

| | |
|---|---|
| get thread information; | // stacks without blocking. |
| scan thread's stack; | // CPU specific. |
| scan thread's registers; | // CPU specific. |
| } | |
| if(!scanHeap(collector) | // Scan everything else in heap; ifoperation |
| | // returns false, abort. See Table 5. |
| shouldAbort = False; | |
| for(thread in threads) { | // Stop each thread in turn and |
| if(shouldAbort) return False; | // fully scan for any new nodes. |
| stop thread; | |
| scan thread's stack; | // CPU specific. |
| scan thread's registers; | // CPU specific. |

if (generation == collector->maxGeneration)

| | |
|---|---|
| shouldAbort = scanHeap(collector); | // Scan all generations. See Table 5. |
| Else | // Scan only certain generations. |

shouldAbort = scan HeapGenerationally(collector, generation);

| | |
|---|---|
| start thread; | // See table 6. |

```
  }
  // Another thread may have set a node's needsScan variable while the
  // preceding code executed. Check for this.
```

| | |
|---|---|
| lock(collector->allocationLock); | // Take the collection lock. |
| lock(collector->garbageLock); | // Take the garbage lock. |
| collector->isScanning = False; | // All reachable nodes have been identified |
| | // so new memory allocations are permitted. |

If(generation == collector->maxGeneration)

| | |
|---|---|
| ShouldAbort = scanHeap(collector); | // Scan all generations. See Table 5. |
| Else | // Scan only certain generations. |

ShouldAbort = scanHeapGenerationally(collector, generation); // See Table 6.

| | |
|---|---|
| Collector->isScanning = False; | // All reachable nodes have been identified |
| | // so new memory allocations are permitted. |
| For(node in collector->nodes { | // Mark relevant nodes as garbage. |

```
    If(node->inUse && !node->wasReached)
      node->isGarbage = True;
  }
```

| | |
|---|---|
| clearWeakReferences( ); | // If weak references are supported. |
| unlock(collector->garbageLock); | // Release the garbage lock. |
| unlock(collector->allocationLock); | // Release the collection lock. |

```
  for(nodes in collector->nodes) { // Reclaim inUse but unreachable nodes.
    if(node->isGarbage && node->isObject)
```

| | |
|---|---|
| collector->finalize(node); | // Execute finalizer routine before reclaiming. |
| } | |
| for(node in collector->nodes) { | // Recover memory. |
| if (node->isGarbage) | |
| node->inUse = False; | |
| } | |
| return True; | |
| } | |

Referring to Table 5, a full generation heap scan marks, as reachable, all nodes that are in-use, part of the root set or that have been marked as “wasReached” by another node's reference. In the illustrative embodiment of Table 5, an iterative (breadth-first) rather than a recursive (depth-first) search has been implemented. A full generation heap scan in accordance with Table 5 begins by setting local variable “nodesExamined” to zero. As discussed below, this variable provides a means for collector 130 to determine if it should abort an on-going collection cycle. For each node in heap 125, use and reachable metadata is checked to determine if the node is currently in use (i.e., allocated) and reachable (i.e., accessible from the thread's root set). If the node's metadata indicates it is appropriate, the node is scanned to determine and identify any other nodes that are reachable from it (see Table 7). Each node so identified is marked as reachable. After each node is inspected in this manner, the nodesExamined variable (see discussion above) is incremented and checked against a threshold value. If the current value of this variable is greater than a specified value (which may be set, for example, when collector 130 is initialized), a check is made to determine if one or more threads indicates that it wants the garbage collection cycle to terminate. By way of example, if a thread determines that it will need more processor time (i.e., CPU cycles) then it is currently receiving, it may set a flag indicating to collector 130 to abort (e.g., the shouldAbort flag as shown in Table 1). This may occur, for instance, when a thread is processing time-critical user interaction events, or processing video and/or audio data.

TABLE 5
Scan Heap Pseudo-Code

```
bool scanHeap(struct Collector *collector) {
  int nodesExamined = 0; // Local control variable.
  while(collector->needsScan) {
    collector->needsScan = False;
    for(node in collector->nodes) {
      if(!node->inUse) continue;
      if(node->wasReached) continue;
      if(node->externalReferencesCount ||
      node->wasReached) && node->isScanned)
        scan(collection, node->userData,
        &node->userData[node->nitems]);
        // See Table 7.
      node->wasReached = True;
      if(++nodesExamined > collector->abortCheckThreshold) {
      if(collector->shouldAbort( )) return False;
          nodesExamined = 0;
      }
    }
  }
  return true;
}
```

Referring to Table 6, a generational heap scan operates in substantially the same manner as a full generation scan (see table 5), with the exception that the heap is scanned on a generational basis. That is, if generation N is being collected, the heap is scanned for all nodes having a generation of between 0 and N inclusive (see Table 8). It is significant to note that, as with a full generation scan (see Table 5), in a generational scan operation retained nodes (i.e., those determined to be reachable) are not moved from one generational space to another as with prior art generational garbage collection techniques.

TABLE 6
Scan Heap Generationally Pseudo-Code

```
bool scanHeapGenerationally(struct Collector *collector, int generation) {
  nodesExamined = 0; // Local control variable.
  while(collector->needsScan) {
    collector->needsScan = False;
    for(node in collector->nodes) {
    if(!node->inUse) continue;
    if(node->wasReached) continue;
    if ((node->hasYounger || node->wasReached) &&
    node->isScanned &&
      node->generationCount <= generation) {
      scanGenerationally(collection, generation, node->userData,
            &node->userData[node->nitems]); // See Table 8.
      node->wasReached = True;
      if (++nodesExamined > collector->abortCheckThreshold) {
        if (collector->shouldAbort( )) return False;
        nodesExamined = 0;
      }
    }
  }
  return true;
}
```

Referring to Tables 7 and 8, nodes are checked to determine if they are reachable and, if they are, their referenced and scan metadata is updated. For example, a node's needsScan variable may be set when an external reference to the node is created, when a weak reference is made to the node, when an internal reference is made to the node or when the node is reached during a heap scan operation. As noted above, during generational scans (Table 8), all nodes whose generation is less than or equal to the specified generation are checked/scanned.

TABLE 7
Scan Pseudo-Code

```
void scan(struct Collector *collector, Node *start, Node *after) {
  while (start < after) {
    if(isNode(collector, start)) { // Validate pointer as pointing to a node.
      if(start->inUse && !start->wasReached) {
        start->wasReached = True;
        if (start->isScanned) {
          start->needsScan = True;
          collector->needsScan = True;
        }
      }
    }
  ++start;
  }
}
```

TABLE 8
Scan Generationally Pseudo-Code

```
void scanGenerationally(struct Collector *collector, int generation,
              Node *start, Node *after) {
  while (start < after) {
    if (isNode(collector, start)) { // validate pointer as pointing to node.
      if(start->inUse && !start->wasReached &&
      start->generationCount <= generation) {
        start->wasReached = true;
        if(start->isScanned) {
          start->needsScan = True;
          collector->needsScan = True;
        }
      }
    }
  ++start;
  }
}
```

As described above, metadata needed by collector 130 has been kept within the node itself. This is not necessary however. In another embodiment, some or all of a node's metadata may be retained in additional data structures separate from the nodes themselves. Assume, for example, that the garbage collector's heap (e.g., heap 125) is comprised of one or more blocks of memory allocated from a virtual memory system. Each block may be divided into uniformly sized quanta and all allocations from within that block are made up as one or more contiguous quanta (by rounding up the requested memory size to that of a quanta multiple). The quanta count within that block for the starting address of a block may be used as an index into one or more bitmaps stored elsewhere that are used to retain metadata. For example, one bitmap could be used to represent the wasReached metadata field. In addition, several metadata fields may be joined into a byte and a byte-map similarly constructed. Those skilled in the art will recognize that if a block is allocated on an alignment equal to the power-of-two size of the block that a simple bit-mask extract and shift operation is sufficient to efficiently calculate the index of any quanta.

From a practical point of view, it is important for a garbage collector such as collector 130 to be able to quickly deny or confirm that a data value is a pointer to an allocated node. If memory blocks used by the collector are allocated and aligned on the same boundaries (e.g., one megabyte allocations aligned on a one megabyte address boundary), a bitmap representing as much as the entire address space can be efficiently computed and stored. Such a bitmap can be used to quickly determine if a value could not possibly be a node pointer by determining, for example, that its block index into that bitmap (i.e., which megabyte in the address space) indicates that it is not in use by the garbage collector. By way of example, in a 32-bit system the top 12 bits of an address may be used as a block index into a bitmap of all possible one megabyte sized and aligned allocations. The lower 20 bits (shifted by the log 2 quanta size, 4 in the case of a 16 byte quanta) could then be used as an index into that block, with the retrieved valuing indicating if the memory is being used by the garbage collector.

Referring again to Table 1, it can be seen that in the illustrative embodiment collector 130 comprises three (3) different locks: allocation, collection and garbage. The collection lock may be taken by any thread that wishes to run a collection (i.e., invoke a collection cycle in accordance with Table 3). In one embodiment this may be an application's “main” thread. In another embodiment, collector 130 may execute on any (arbitrary) thread within the application. The allocation lock is taken by a thread when it attempts to allocate memory (or, more precisely, when the run-time environment's allocation module attempts to allocate memory for the thread) and is released when the allocation is complete. The primary purpose of the allocation lock is to prevent two threads from claiming/using the same memory at the same time. The garbage lock is taken by the collector after heap scan operations are complete and is released just prior to finalization operations (see Table 4). The garbage lock may also be taken by other threads attempting to revive a weakly referenced node. Accordingly, the garbage lock is relied upon by the weak reference system to prevent weakly referenced nodes from being prematurely collected (i.e., marked as garbage and reclaimed). It will be recognized that because only a limited number of locks are used to control the collection cycle set forth in Tables 1-8, collection is performed by a single thread. That is, multiple threads cannot be “collecting” heap 125 at the same time. This, however, is not a limitation of the claimed invention but rather a policy adopted for the specific implementation described here.

For efficiency and computational throughput, it can be important to allow threads to proceed while a collection operation is in progress (i.e., continue to compute). It will be recognized, however, that threads may alter the graph of reachable objects. It is the function of the various locks described herein to guard against non-collecting threads from perturbing the collection of reachable nodes in a manner that is transparent to the collecting thread.

As noted above, a thread performing computation has an associated stack of procedure frames containing variables that can reference heap nodes. In some programming languages such as C, for example, the address of a stack variable may be passed as a parameter to a procedure higher on the stack, whereafter that (higher on the stack) procedure may store a node reference into that variable or, fetch and modify the referenced node. In general, then, a thread's procedures may move or exchange references throughout its stack.

Referring to Table 4, to discover the complete set of references on a thread's stack the stack is scanned without stopping the thread under the expectation that references are not being moved among the stack frames. Next, the heap is examined and, only then, are threads stopped (one at a time) and examined to identify any “newly” created node references. At the point where a thread is unblocked, its stack contains no references to heap nodes that are not already marked reached.

In addition, if a stack contains a reference that the thread marks as “external,” it takes the garbage lock and sets collector 130's needsScan flag to ensure that collector 130 will again search all nodes to find which are reachable (e.g., by setting the node's needsScan variable, see Table 2). It is also possible for a thread to revive a node via a weak reference after its stack has been examined. To prevent this from causing a heretofore reachable node from being marked as garbage, a weak reference system may take the garbage lock and mark the (revived) node as needing to be scanned if it has, in fact, not yet been reached. (It will be recognized that a weak reference system is a system that maintains addresses that reference nodes in a weak manner.) Finally, a node being scanned could have an already scanned location set to an unreached object through a write-barrier. To avoid this, the write-barrier may check to determine if scanning is in progress and, if so, marks the object as having been reached (e.g., by setting the node's wasReached variable) and as needing to be scanned (e.g., by setting the node's needsScan variable).

Various changes in the components, circuit elements, as well as in the details of the illustrated operational methods and pseudo-code are possible without departing from the scope of the following claims. For example, garbage collector objects (see Table 1) and node objects (see Table 2) may include fewer or more fields than described herein. Further, acts in accordance with pseudo-code Tables 1-8 may be performed by a programmable control device executing instructions organized into one or more program modules. A programmable control device may be a single computer processor, a special purpose processor (e.g., a digital signal processor, “DSP”), a plurality of processors coupled by a communications link or a custom designed state machine. Custom designed state machines may be embodied in a hardware device such as an integrated circuit including, but not limited to, application specific integrated circuits (“ASICs”) or field programmable gate array (“FPGAs”). Storage devices suitable for tangibly embodying program instructions include, but are not limited to: magnetic disks (fixed, floppy, and removable) and tape; optical media such as CD-ROMs and digital video disks (“DVDs”); and semiconductor memory devices such as Electrically Programmable Read-Only Memory (“EPROM”), Electrically Erasable Programmable Read-Only Memory (“EEPROM”), Programmable Gate Arrays and flash devices.

1. A dynamic memory management method, comprising:
identifying at least one heap object as reachable and at least one heap object as not reachable, the heap objects associated with an executing program having multiple threads, wherein the act of identifying blocks only one of the multiple threads at a time for dynamic memory management operations;
terminating the act of identifying if at least one of a specified plurality of acts occur, else continuing with dynamic memory management operations; and
reclaiming the at least one heap object identified as not reachable, wherein the act of reclaiming does not copy the at least one heap object identified as reachable.

2. The method of claim 1, wherein the executing program comprises a user program.

3. The method of claim 1, wherein the act of identifying comprises:
performing a first scan to identify one or more reachable heap objects without halting any of the multiple threads to facilitate the act of performing the first scan; and
performing a second scan to identify one or more reachable objects wherein each of the multiple threads are halted, one at a time, in turn to facilitate the act of performing the second scan.

4. The method of claim 1, wherein the at least one of the specified plurality of acts comprises a user interaction event.

5. The method of claim 1, wherein the acts of identifying, terminating and reclaiming use one of the multiple threads associated with the executing program.

6. The method of claim 1, wherein the acts of identifying, terminating and reclaiming use a thread distinct from any one of the multiple threads associated with the executing program.

7. The method of claim 1, wherein the acts of identifying, terminating and reclaiming are applied to heap objects having a specified generation.

8. The method of claim 1, further comprising performing the acts of identifying, terminating and reclaiming only to heap objects having a generation value less than or equal to a specified generation value.

9. A program storage device, readable by a programmable control device, comprising instructions for causing the programmable control device to perform acts in accordance with claim 1.

10. A method to manage heap memory for an application having a plurality of threads, each thread having an associated stack memory, comprising:
identifying root objects of the application by inspecting only the plurality of stacks and the heap memory, wherein the act of identifying is performed concurrently with continued execution of one or more of the application threads;
interrogating the heap memory to identify other heap objects reachable from the root objects, wherein the act of interrogating is performed concurrently with continued execution of one or more of the application threads;
performing a catch-up scan of each of the plurality of application threads to further identify objects reachable from the root objects, wherein each of the plurality of threads is halted only during catch-up scan operations directed to a stack memory associated with the thread; and
reclaiming heap memory not identified as being associated with a root object or an object reachable from a root object.

11. The method of claim 10, wherein the acts of identifying, interrogating, performing and reclaiming use a thread associated with the application.

12. The method of claim 11, wherein the application comprises a user application.

13. The method of claim 10, wherein the acts of identifying, interrogating, performing and reclaiming use a thread associated with an operating system routine.

14. The method of claim 10, wherein the act of identifying is invoked explicitly by the application.

15. The method of claim 10, further comprising:
executing a function during the acts of interrogating to determine if an event has occurred; and
aborting the method to manage heap memory if execution of the function indicates the event has occurred.

16. The method of claim 15, wherein the executed function is a function registered with a run-time environment associated with the application.

17. The method of claim 15, wherein the event comprises a user-interface event.

18. The method of claim 10, wherein the act of reclaiming comprises permitting heap memory other that that identified during the acts of identifying and interrogating to be used in a subsequent heap memory allocation operation.

19. The method of claim 10, further comprising executing a finalization action for one or more heap objects identified during the acts of identifying and interrogating, wherein the finalization action occurs after the act of performing and before the act of reclaiming.

20. The method of claim 10, wherein the act of reclaiming heap memory is performed without copying heap objects identified during the acts of identifying, interrogating and performing from a first location to a second location.

21. The method of claim 10, wherein the acts of identifying, interrogating, performing and reclaiming are performed for a specified generation of objects stored in the heap memory.

22. A program storage device, readable by a programmable control device, comprising instructions for causing the programmable control device to perform acts in accordance with claim 10.

23. A computer system, comprising:
a heap of dynamically allocated storage;
a task executed by the computer system which accesses objects stored in the heap, the task having a plurality of threads; and
a garbage collection task for recovering unused storage in the heap, the garbage collection task comprising instructions executable by the computer system to
identify root objects of the task by inspecting only the heap and stack memory associated with each of the plurality of threads, wherein the instructions to identify may be performed concurrently with continued execution of instructions associated with one or more of the threads,
interrogate the heap memory to identify other heap objects reachable from the root objects, wherein the instructions to interrogate may be performed concurrently with continued execution of instructions associated with one or more of the threads,
perform a catch-up scan of each of the one or more threads to further identify objects reachable from the root objects, wherein the instructions to perform cause each of the plurality of threads to be halted only during catch-up scan operations directed to a stack memory associated with the thread, and
reclaim heap memory not identified as being associated with a root object or an object reachable from a root object.
